(19) United States
(12) Patent Application Publication
(10) Pub. No.: US 2026/0366581 A1
(43) Pub. Date: Nov. 19, 2026

(54) FIXED CALIPER BODY FOR A DISC BRAKE DISC

(71) Applicant: BREMBO NORTH AMERICA, INC., Plymouth, MI (US)

(72) Inventor: Matthew BAUER, Plymouth, MI (US)

(21) Appl. No.: 19/679,153

(22) Filed: May 15, 2026

(30) Foreign Application Priority Data
May 16, 2025 (IT) 102025000011046

(51) Int. Cl. F16D 55/22; F16D 65/00; F16D 55/00

(52) U.S. Cl. CPC F16D 55/22; F16D 65/0075; F16D 2055/002

(57) ABSTRACT

The described technology pertains to the field of disc brake systems, specifically focusing on a fixed caliper body (1) for disc brakes (14) used in vehicles, particularly high-performance motor cars. The technical problem addressed is the need for a caliper body that is lightweight yet capable of supporting high braking forces without excessive deformation, while simplifying manufacturing processes. The solution involves a caliper body composed of two half caliper bodies (2, 3) with thrust seats (4, 5; 6, 7) for thrust devices (8, 9; 10, 11) and central bridge portions (19, 20) that create a tierod above the pads (12, 13). The caliper body includes end bridges (23, 24) that connect the half bodies, ensuring precise alignment and reducing vibrations. This design optimizes conflicting requirements of stiffness, weight reduction, and manufacturing simplicity, enhancing braking comfort and performance.

### CROSS-REFERENCE TO RELATED APPLICATIONS

The present application claims the priority benefit of IT Pat. App. No. 2025000011046 to Bauer, filed on May 16, 2025, which is fully incorporated by reference herein in its entirety.

### BACKGROUND

The present invention relates to a disc brake caliper body, preferably of fixed caliper type, which can be used on vehicles and in particular, but not necessarily, intended for high-performance motor cars.

The present invention further relates to a disc brake caliper and to a disc brake assembly having a caliper body of the type specified above.

In a disc brake, the brake caliper is generally arranged straddling the outer peripheral margin of a brake disc, adapted to rotate about a rotation axis (A-A) defining an axial direction (X-X). In a disc brake, a radial direction (R-R), arranged substantially orthogonal to said axial direction (X-X), and a punctually tangential or altogether circumferential direction (C-C), orthogonal to both said axial direction (X-X) and said radial direction (R-R), is further defined.

It is known that a caliper body of fixed caliper disc brake can be associated with a disc so as to maintain its distance from the disc unchanged. Said known caliper body comprises a first half-body, adapted to accommodate first means for generating a braking action, arranged facing a first braking surface of an outer side of said disc, as well as a second half-body, adapted to accommodate second means for generating the braking action, arranged facing a second braking surface of an inner side of said disc. Said first and second half-bodies are connected, by means of fixing means, to two bridge elements arranged straddling the disc.

The expression “outer side” means the side of the disc brake assembly which faces towards the outside of the vehicle when it is fitted on the hub and stub axle, or hub-holder, of the wheel. Similarly, the expression “inner side” means the side of the assembly which faces towards the inside of the vehicle when it is fitted on the wheel hub.

As known, the discs for disc brakes comprise a bell, adapted to associate the disc with a vehicle hub, from which an annular portion, named braking band, intended to cooperate with pads of a caliper, extends.

Said braking band is intended to cooperate with calipers for disc brake adapted to apply a braking action on the vehicle, whereby applying, by means of pads, friction on opposite surfaces of the two plates, named braking surfaces.

It is known that during the operation of the brakes, the friction between the pads of the brake calipers and the braking surfaces of the braking band generates a high amount of heat which needs to be disposed of.

Indeed, the generated heat determines the onset of many undesired phenomena, such as, for example, the deformation of the braking band, the formation of cracks on the braking surfaces or localized state transformations of the material constituting the braking band which, in turn, lead to the deterioration of the braking band itself.

As mentioned above, during the braking of a vehicle, the significant and high forces which bias the caliper body are a clamping action and a braking action. These actions are produced by the means adapted to generate the braking action, e.g. at least one pair of cylinder and piston assemblies, accommodated in the half-bodies, the pistons of which act by means of the pads on the opposite braking surfaces of the disc.

The clamping action of the pads against the braking surfaces of the disc is directed axially and is balanced by the structure of the caliper body which is arranged straddling the disc. In particular, such action is contrasted by the bridge elements which, by embracing the disc, form closed force loops. This action biases the caliper body, determining a spreading of the bridge elements, or, in other words, a bending of the caliper body along the axes in tangential direction, or with concavity about radial axes.

The braking action is instead directed tangentially and in particular in the rotation direction of the disc. This action is transmitted by the disc to the pads and contrasted by shoulders provided in the bridge elements, so as to be released onto the supporting means of the caliper body which are rigidly coupled, for example, to a stub axle or hub-carrier of a wheel of the vehicle. This action biases the bridge elements whereby also deforming portions thereof necessary to connect the half-bodies. Furthermore, the braking action is released onto the supporting means only on the side of the caliper body facing the inner side of the disc, whereby also determining a bending of the caliper body about the radial axes.

The aforesaid actions are notoriously not uniformly distributed on the caliper body and are of a magnitude which is variable over time, whereby causing, in addition to deformations of the caliper body which are sometimes unacceptable for a correct operation of the disc brake, also vibrations and undesired screeching.

Therefore, the need is strongly felt to suggest a caliper body of fixed caliper disc brake, which has such structural and functional characteristics as to overcome the aforesaid disadvantages described with reference to the prior art and in particular to lighten the caliper body but at the same time strengthen the bridge elements arranged straddling the disc brake and at the same time simplify the construction of the caliper body and especially the working of the thrust device housings, e.g. of the cylinders adapted to accommodate the thrust pistons adapted to bias the brake pads.

In some prior art solutions, especially for medium-to-low-performance vehicles, it is known to use a disc brake of the floating caliper type, in which a caliper having a single piston or multiple pistons but all on the same side of the disc brake is supported in the condition that the brake caliper can be freely moved with respect to a supporting element, or bracket, which is fixed to a fixed part of a vehicle, e.g. to the hub-holder, to support the pair of brake pads and with a sliding constraint which allows the supporting element to float or move freely with respect to the disc. As mentioned, in the case of the aforesaid disc brake with floating caliper, the piston is arranged only on one side of the rotor, i.e. the piston is arranged only on the inner side, or vehicle side, of the disc.

In the case of high-performance vehicles, opposed piston disc brakes have become common, because they can produce an excellent braking force, by virtue of their greater efficiency. In the disc brake of the opposed piston type, pistons are provided on both sides of a disc brake. During braking operations, a pair of pads is pushed against both opposite braking surfaces of the disc brake rotor by both opposite pistons. In this opposite piston disc brake, the rotor of the brake disc is interposed between the cylinders adapted to accommodate the pistons and the open sides of the cylinders are opposite to one another.

Therefore, in these high-performance vehicles, the need is strongly felt for a caliper body of great stiffness able to maintain the orthogonality between the bridge elements and the half-bodies facing the braking surfaces of the brake disc.

Document GB2214581 by Freni Brembo S.p.A. shows a single-block brake caliper body solution with opposed pistons or fixed caliper body.

Indeed, this single-block caliper body has a structure in which the elongated portions facing the disc brake have a plurality of cylinders integrated in a single body. However, the structure described in the aforesaid patent publication is disadvantageous in that it requires time and complex special methods for working the cylinders and assembling the disc brake of the opposed piston type made in a single block. Therefore, it is impossible to avoid an increase in production costs.

In order to simplify the working of the cylinders, solutions are known in which the calipers are made in two halves and then joined.

In this case, the body having a plurality of cylinders is divided into half-bodies having an attachment portion, or attachment half-body, to be connected to a stationary portion of a vehicle, e.g. a hub-holder, and also having a cylinder on the inner front side, and a portion or outer body having a cylinder on the outer front side. After both bodies have been worked to form the cylinders required in them, the half-bodies are connected and fixed to one another by bolts.

Examples of these caliper bodies are known from GB936222 by DUNLOP RUBBER CO; US3261429 by Bendix Corp.; US5538105 by DAYTON WALTHER CORP and US5819886 by Robert Null.

However, in the known structure mentioned above of the caliper in two parts, the bolts for attaching and fixing the inner body and the outer body to one another receive a braking torque which is given by the outer brake pad and biased by the pistons of the outer body, braking action generated by the friction caused between the outer side face of the rotor, or disc brake, and the outer pad in the braking process. It is therefore necessary for the bolts to withstand this braking torque. Therefore, the diameters of the bolts must be large in size, to the extent of increasing size and weight of the caliper body. The weight of the disc brake, which is supported in an end portion of the angle portion of a vehicle, or corner, becomes an unsprung weight, i.e. not suspended by elastic and/or damping elements. Accordingly, even when the weight of the disc brake increases only slightly, the running performance of a vehicle is also strongly biased by the increase of unsprung weight.

Therefore, the need is strongly felt also to reduce the overall weight of the fixed brake caliper.

This need, combined with the contrasting one of stiffening the caliper body and further the contrasting need of simplifying the working of the thrust means housings, has led to some known solutions which however do not optimize these conflicting requirements.

For instance, there is the solution of US6260670 by AKEBONO BRAKE IND of two-part caliper, the solution of EP1303708B1 by Freni Brembo S.p.A. of three-part caliper, the solution of US2009236187 of CONTINENTAL TEVES AG & Co OHG of three-part caliper, the solution of US2006231354 by WARREN, the solution of US2010170755 by Robert Biggs and the solution of WO201491423 by Franco Iorio.

The solution of US5515948 by Gilliland also shows a caliper in multiple parts connected together by calibrated pins extending straddling the disc brake. This known solution, in order to allow to have the desired strength and mechanical rigidity, requires however calibrated pins and connections between the different parts of considerable diameter, whereby causing considerable radial dimensions of the caliper as a whole, resulting in a solution which is not very suited to the current requirements of a large-size brake disc rotor adapted to increase the range of action of the braking action which leaves very little space between itself and the inner surface of the rim of the vehicle wheel. Furthermore, this known solution which requires large-size steel pins is not optimal for the need of reducing the overall weight of the brake caliper.

Therefore, the need remains strongly felt to provide a fixed caliper body in separable parts but which ensures an accurate alignment of the bridges and of the elongated elements which ensures a perfect orthogonality between the components, which orthogonality does not create problems for pads, such as jamming and non-uniform wear thereof.

Therefore, the need remains strongly felt to improve the accuracy with which the connection elements, or bridges, are connected to the half-bodies, in order to stiffen the parallelogram created by the half-bodies and the bridges. The further need is felt to provide a supporting surface of the bridge connection elements either parallel or perpendicular to the releasing plane of the braking action.

The problem underlying the present invention is thus to provide a fixed caliper body and a caliper, which have structural and functional characteristics such as to satisfy the aforementioned requirements and at the same time solve the drawbacks mentioned with reference to the prior art.

### SUMMARY OF THE INVENTION

An object of the present invention is to provide a fixed caliper body, a brake caliper and a braking device in which the aforesaid mutually conflicting requirements are achieved and optimized.

This and other objects and advantages are achieved by a caliper body and a brake caliper as described and claimed herein.

Advantageous embodiments are also described.

The analysis of this solution shows that the suggested solution allows obtaining a caliper body which is light but at the same time able to support high braking actions without being excessively deformed and without exceeding in its overall dimensions.

Furthermore, the suggested solution allows considerably simplifying the working operations of the half-bodies of the caliper.

Furthermore, the suggested solution allows obtaining a braking comfort much higher than the solutions of the prior art, and consequently a reduction of the vibrations and in particular an absence of the vibrations which cause screeching.

One of the aspects of the described configuration lies in the distinctive arrangement of a composed fixed caliper with an integrated tierod, which enhances the structural integrity and performance of brake systems.

Unlike traditional designs, this configuration incorporates an additional bridge above the brake pads, integrated into the two aluminum half caliper bodies and connected with half caliper screws.

This arrangement introduces three separate union planes, ensuring that the screw tightening procedure does not introduce undesirable stress to the caliper bodies.

The described configuration also features a particular tolerance scheme that ensures the least favorable gap 44 is present only at the union of the integrated tierod, maintaining acceptable stress levels within the caliper bodies.

Additionally, the use of different materials, such as aluminum for the half caliper bodies and cast iron for the end bridges, further distinguishes this approach from existing designs, offering improved stiffness and reduced weight. This innovative method addresses the limitations of current brake caliper designs by enhancing stiffness and reducing the complexity of manufacturing processes.

In the field of disc brake systems, particularly those used in high-performance vehicles, there is a persistent challenge in balancing the need for a lightweight caliper body with the requirement for high structural stiffness and efficient heat dissipation. Traditional fixed caliper designs often struggle with excessive deformation under high braking forces, leading to reduced braking efficiency and increased wear on the brake pads. This deformation is primarily due to the significant forces exerted during braking, which can cause the caliper body to spread, resulting in undesirable vibrations and noise, such as screeching.

Solutions that have been previously developed have attempted to address these issues through various configurations, including single-block caliper bodies and multi-part assemblies. Single-block designs, while offering improved stiffness, often require complex manufacturing processes and result in increased production costs. Multi-part assemblies, in contrast, can introduce alignment challenges and require large, heavy components to withstand the braking torque, thereby increasing the unsprung weight of the vehicle. This added weight negatively impacts the vehicle's handling and performance.

The present solution addresses these challenges by introducing a novel fixed caliper body design that optimizes the conflicting requirements of stiffness, weight reduction, and manufacturing simplicity. The approach features a composed fixed caliper with an integrated tierod, enhancing the structural integrity and performance of brake systems. This configuration incorporates an additional bridge above the brake pads, integrated into two aluminum half caliper bodies, and connected with half caliper screws. The design ensures precise alignment and reduces vibrations, thereby improving braking comfort and performance. By utilizing different materials, such as aluminum for the half caliper bodies and cast iron for the end bridges, the solution achieves improved stiffness while reducing overall weight, addressing the limitations of existing brake caliper designs.

The claims describe a fixed caliper body for a disc brake disc, which includes two half caliper bodies facing each other, each with thrust seats for thrust devices that push pads against the disc brake. The caliper body features central bridge portions that protrude in a cantilevered manner, creating a bridge that straddles the disc brake and forms a tierod above the pads. Additionally, the caliper body includes separate end bridges with coupling surfaces that connect to the half caliper bodies.

This arrangement enhances the structural integrity of the caliper body by distributing the braking forces more evenly across the caliper structure. The cantilevered central bridge portions provide a robust framework that resists deformation under high braking forces, maintaining the orthogonality between the bridge elements and the half-bodies. This design minimizes the spread of the caliper body, reducing vibrations and noise, such as screeching, during braking operations. The use of separate end bridges allows for precise alignment and secure attachment, ensuring that the caliper body remains stable and effective in its braking function. By integrating the tierod above the pads, the design optimizes the load distribution, enhancing the caliper's ability to withstand high braking forces without excessive deformation. This configuration also simplifies the manufacturing process by allowing for modular assembly, reducing production costs and improving the overall efficiency of the brake system.

The development of the composed fixed caliper with integrated tierod offers several technical effects that enhance the performance and efficiency of brake systems.

Firstly, the integration of an additional bridge above the pads into the two aluminum housings, connected with half caliper screws, significantly improves the structural integrity and stiffness of the caliper body. This configuration ensures that the caliper can withstand high braking forces without excessive deformation, thereby maintaining the orthogonality between the bridge elements and the half-bodies.

Secondly, the design incorporates three separate union planes, which, along with a particular tolerance scheme, ensure that the screw tightening procedure does not introduce undesirable stress to the caliper bodies. This precise alignment reduces vibrations and noise, such as screeching, during braking operations, enhancing braking comfort.

Additionally, the use of different materials, such as aluminum for the half caliper bodies and cast iron for the end bridges, optimizes the balance between weight reduction and stiffness, addressing the limitations of existing brake caliper designs.

The modular assembly approach simplifies the manufacturing process, reducing production costs while ensuring accurate alignment and secure attachment of components.

Overall, these technical effects contribute to a lightweight yet robust caliper body capable of supporting high braking forces, improving the overall efficiency and performance of the brake system.

### BRIEF DESCRIPTION OF THE DRAWINGS

Further features and advantages of the brake caliper and of the brake disc will be apparent from the following description of its preferred embodiments, by way of non-limiting examples, with reference to the accompanying figures, in which:

FIG. 1 is a wheel side axonometric view of a fixed brake caliper according to the invention;

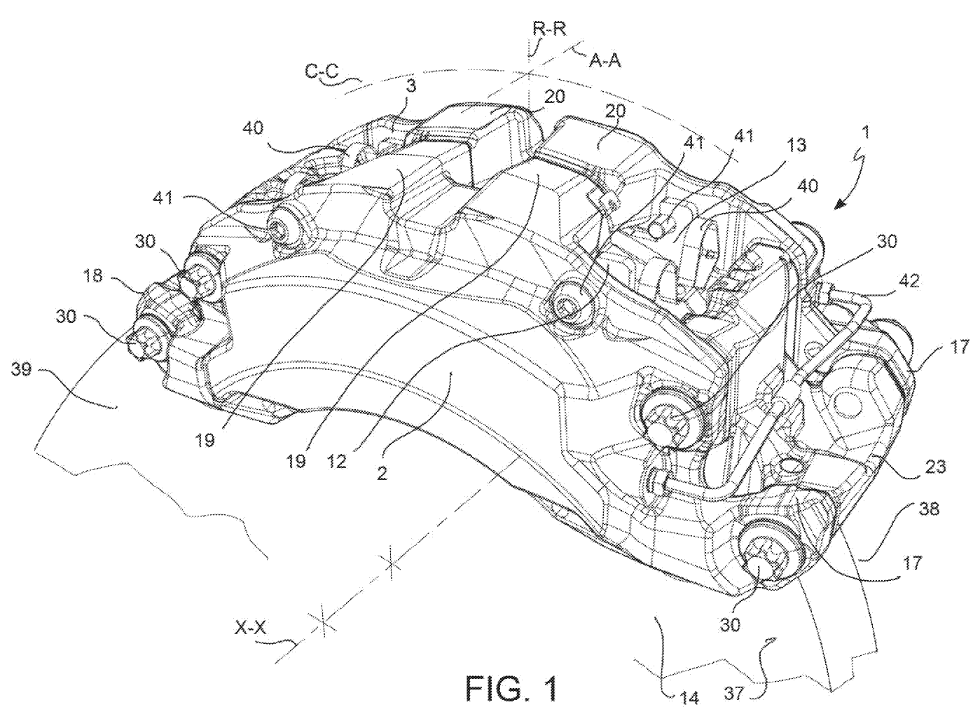

FIG. 2 shows an axonometric view from a different point of view, on vehicle side, of the caliper in FIG. 1;

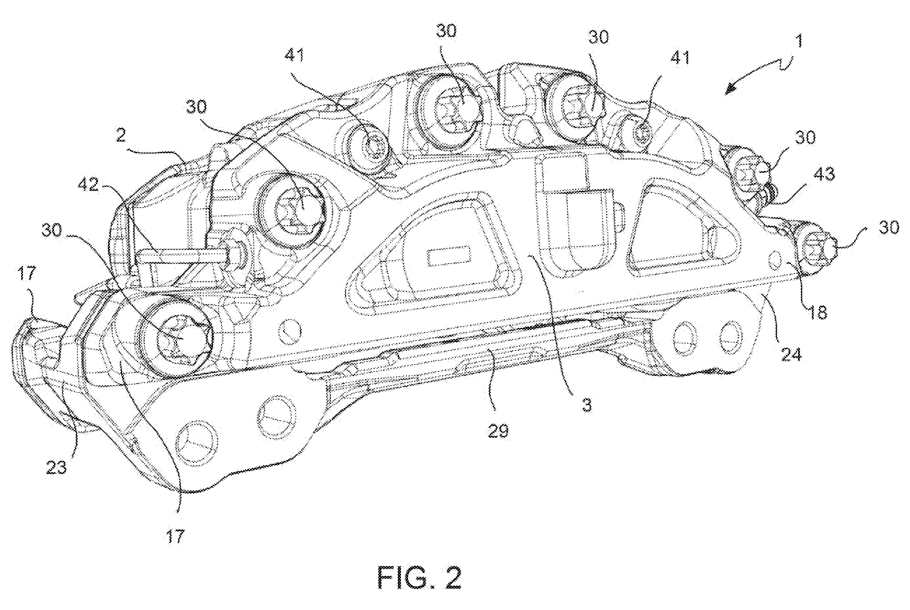

FIG. 3 is a wheel side axonometric exploded view of the caliper in FIG. 1;

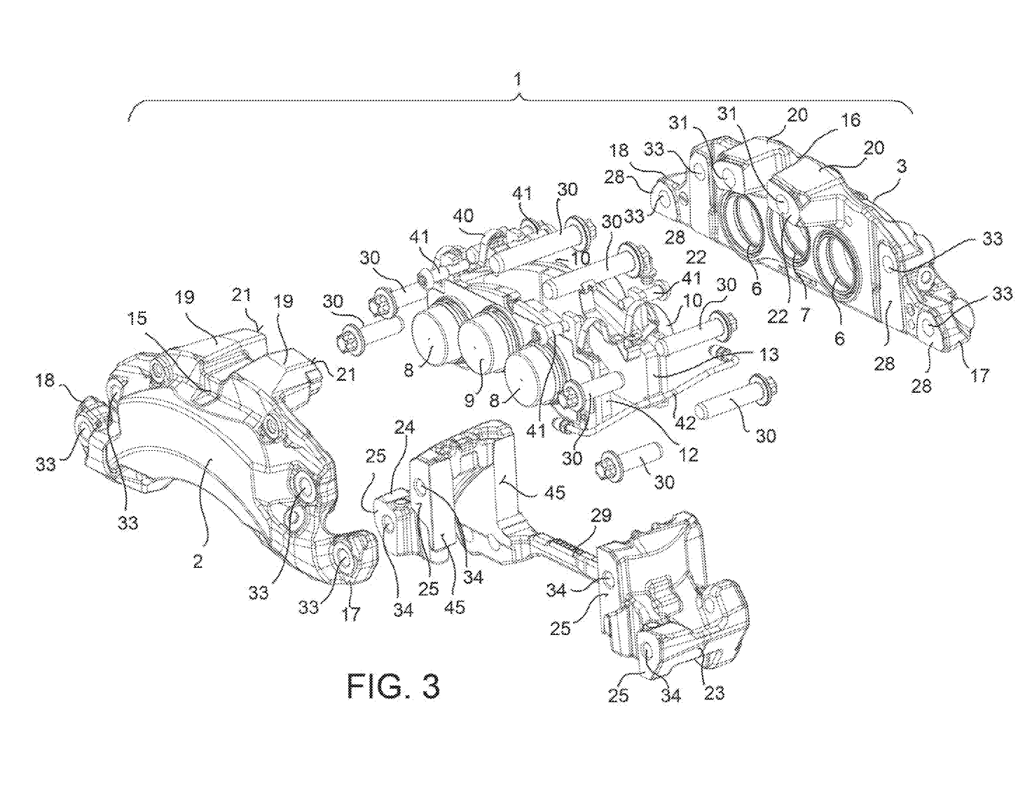

FIG. 4 is a vehicle side axonometric exploded view of the caliper in FIG. 1;

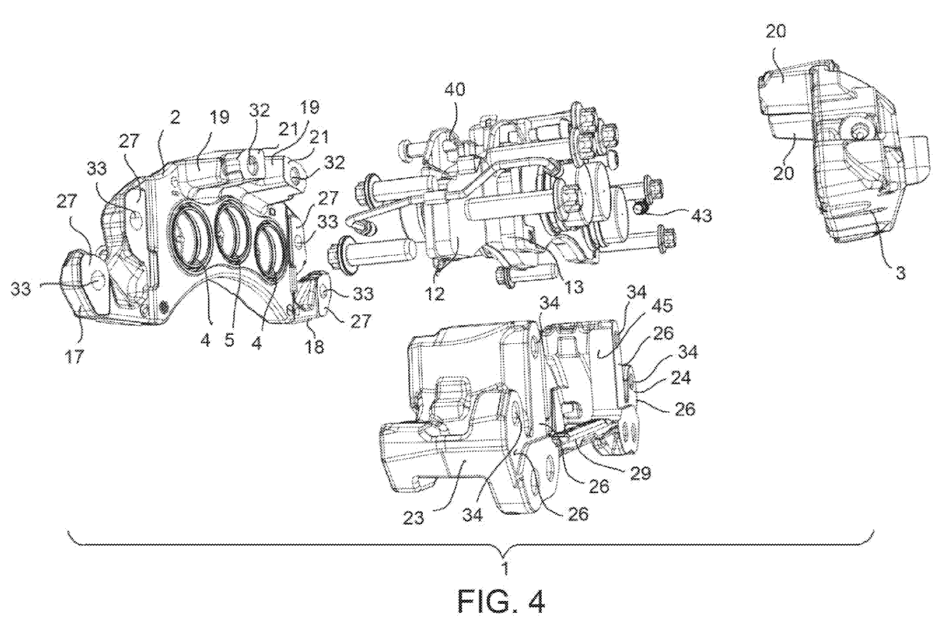

FIG. 5 is a wheel side axonometric exploded view of the caliper according to a further embodiment;

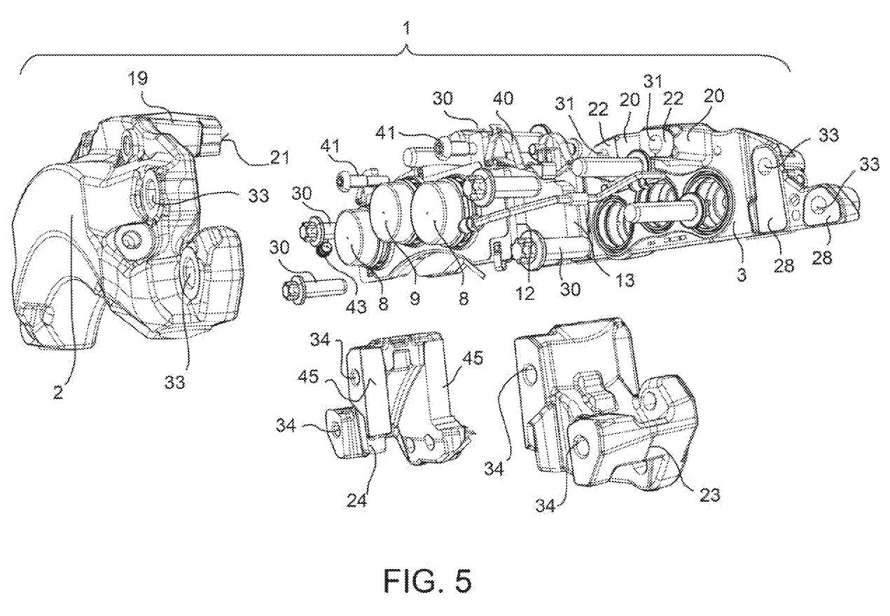

FIG. 6 is a vehicle side axonometric exploded view of the caliper in FIG. 5;

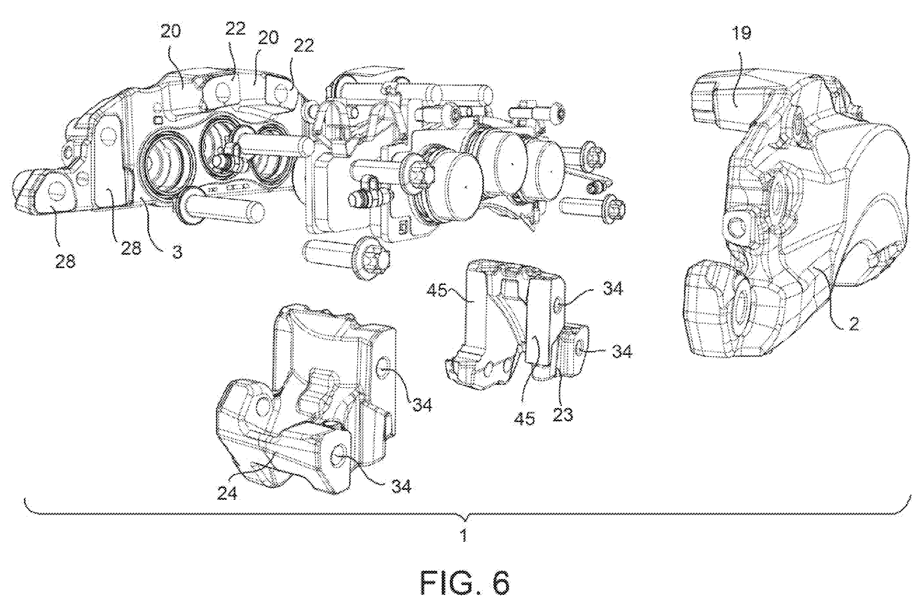

FIG. 7 is a top view of the caliper in FIG. 1, where the connecting planes between the different components are highlighted;

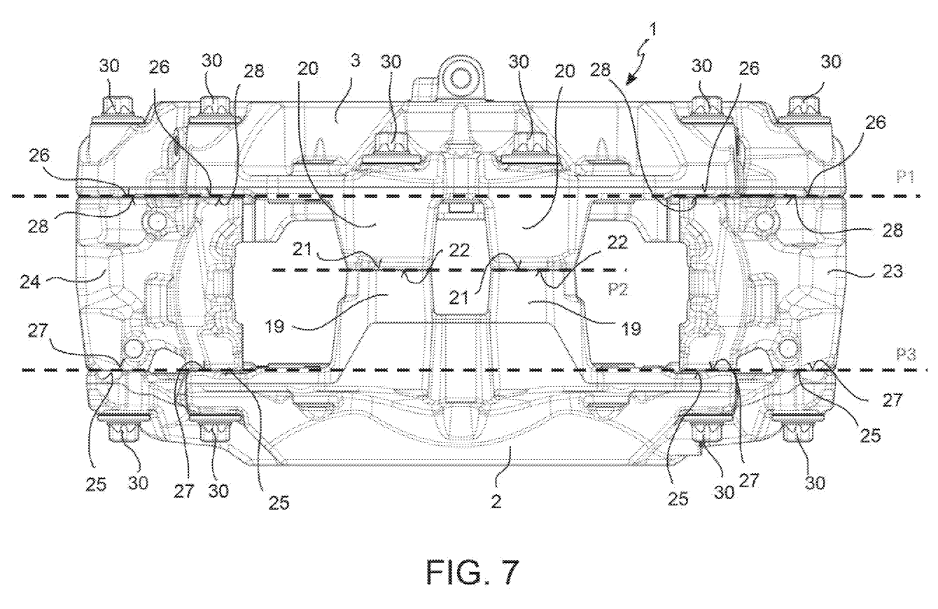

FIG. 8 is a circumferential view of the caliper in FIG. 1, where the connecting planes between the different components are highlighted;

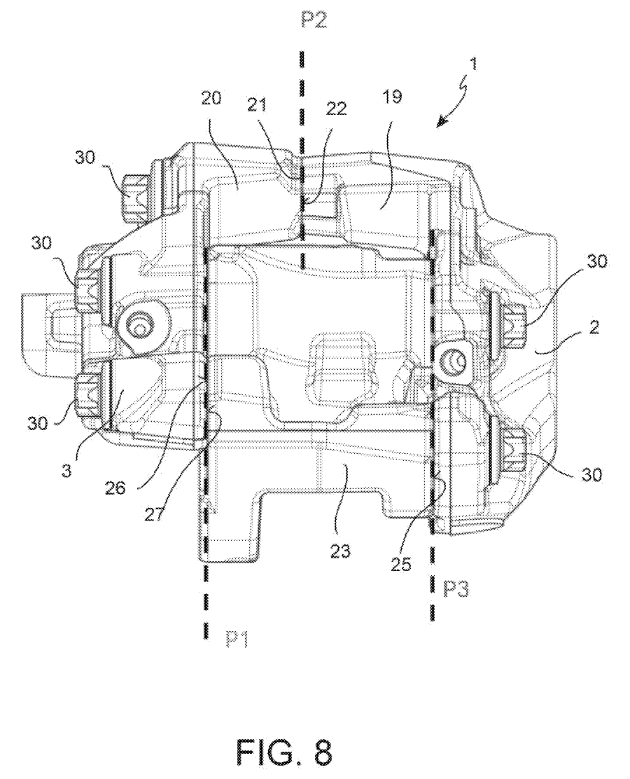

FIG. 9 is a circumferential view of a brake caliper according to a further embodiment where a small gap is present between the faced bridge free end surfaces of the central bridge portions of the half caliper external body and half caliper internal body; and an enlargement of this area.

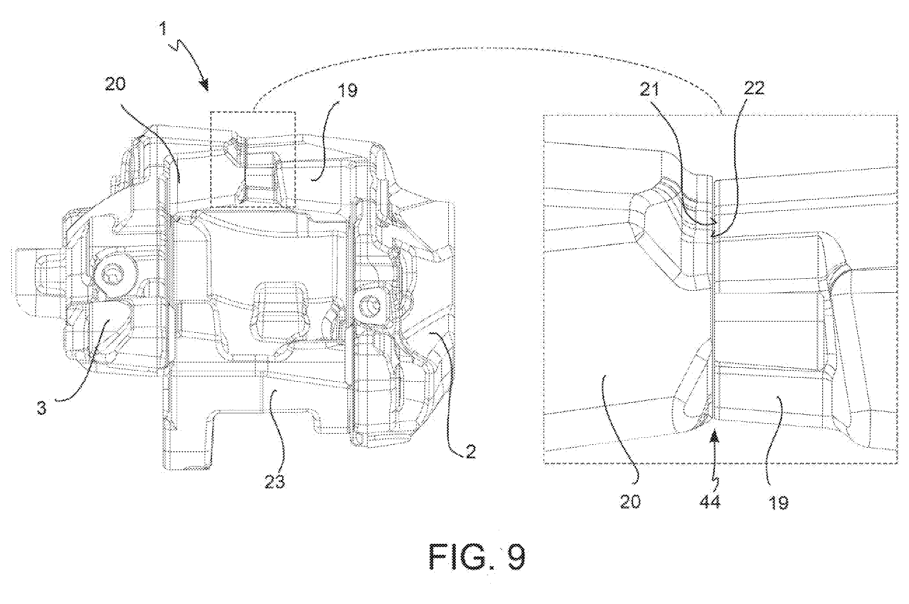

### DETAILED DESCRIPTION

The term “half caliper body” means a component of a disc brake system, specifically part of a fixed caliper body. It is one of the two separate pieces that face each other across the disc brake, housing thrust seats for thrust devices that push brake pads against the disc. Each half caliper body includes a central portion and end portions, and is designed to accommodate the mechanical components necessary for generating braking force.

The term "central portion" in the context of a fixed caliper body for a disc brake refers to the main section of each half caliper body that houses the thrust seats for the thrust devices. This portion is integral to the structure of the half caliper body and serves as the foundation from which the central bridge portions protrude. The central portion is designed to accommodate the mechanical components necessary for generating braking force and plays a critical role in maintaining the alignment and stability of the caliper body during braking operations.

The term "half caliper end portion" refers to a section of a half caliper body in a disc brake system. It is positioned circumferentially outside the thrust seat for the thrust device, contributing to the structural framework of the caliper body. This portion interfaces with other components, such as end bridges, to form secure connections that enhance the caliper's structural integrity and performance during braking operations.

The term “central bridge portion” in the context of a fixed caliper body for a disc brake refers to a structural component that protrudes in a cantilevered manner from the central portion of each half caliper body. It is designed to face the opposite central bridge portion of the other half caliper body, creating a bridge that straddles the disc brake. This configuration helps to form a tierod above the brake pads, contributing to the structural integrity and stability of the caliper body by distributing braking forces evenly.

The term "half caliper coupling surface" refers to the specific area on a half caliper body of a disc brake system that is designed to interface with another component, such as an end bridge, to form a secure connection. This surface is typically machined to precise tolerances to ensure accurate alignment and firm attachment, contributing to the structural integrity and performance of the brake caliper assembly.

An "end bridge" in the context of a fixed caliper body for a disc brake system refers to a structural component that is made as a separate piece from the half caliper bodies. It is designed to straddle the disc brake and connect the half caliper bodies, providing structural support and stability. The end bridge typically features coupling surfaces that interface with the half caliper bodies to form secure connections, enhancing the caliper's ability to withstand braking forces and maintain alignment during operation.

The term "end bridge coupling surface" refers to a specific area on an end bridge of a disc brake system that is designed to interface with another component, such as a half caliper body, to form a secure connection. This surface is typically machined to precise tolerances to ensure accurate alignment and firm attachment, contributing to the structural integrity and performance of the brake caliper assembly.

The term "bridge free end surface" refers to the exposed end surface of a bridge portion in a fixed caliper body for a disc brake system. This surface is part of the central bridge portion that protrudes in a cantilevered manner from the half caliper body and faces the opposite bridge free end surface of the other half caliper body. The alignment and interaction of these surfaces are crucial for creating a bridge that straddles the disc brake, contributing to the structural integrity and stability of the caliper body by evenly distributing braking forces.

A “circumferential rod” (or cross bar, or tangential bar) in the context of a disc brake system is a structural component that connects two end bridges of a brake caliper, typically running along the circumferential direction of the brake disc. This rod helps to maintain the alignment and structural integrity of the caliper assembly by providing additional support and stability, especially under the high forces experienced during braking operations.

A “captive screw” is a type of fastener designed to remain attached to a component even when loosened, preventing it from being completely removed. This is achieved through a special design that includes a retaining feature, such as a shoulder or a washer, which keeps the screw in place within the component. Captive screws are commonly used in applications where it is important to prevent the loss of screws during maintenance or assembly, such as in automotive components or machinery.

In accordance with a general embodiment, the fixed caliper body 1 for a disc brake disc 14 comprises two half caliper bodies 2, 3 facing each other, either directly or indirectly through pads and the disc brake. Each half caliper body 2, 3 includes at least one thrust seat 4, 5; 6, 7 for accommodating thrust devices 8, 9; 10, 11 that push pads 12, 13 against the disc brake 14. Above the thrust seat, each half caliper body 2, 3 features a central portion 15, 16. Additionally, each half caliper body 2, 3 has at least one half caliper end portion 17, 18 disposed circumferentially outside the thrust seat. The half caliper bodies 2, 3 also include at least one central bridge portion 19, 20, which protrudes in a cantilevered manner in the axial direction X-X and is connected in one piece to the central portion 15, 16. The central bridge portion 19, 20 comprises a bridge free end surface 21, 22 facing the opposite bridge free end surface 22, 21 of the faced half caliper body 2, 3, creating a bridge that straddles the disc brake and forms a tierod above the pads 12, 13. The caliper body 1 further includes at least one end bridge 23, 24 made as a separate piece from the half caliper bodies 2, 3, suitable to straddle the disc 14, with faced away end bridge coupling surfaces 25, 26. Each half caliper end portion 17, 18 comprises a half caliper coupling surface 27, 28 facing the end bridge coupling surface 25, 26 to firmly connect the half caliper bodies 2, 3 with the end bridge 23, 24 in a removable manner.

The advantages of these essential features include enhanced structural integrity and stability of the caliper body, efficient distribution of braking forces, reduced deformation under high braking forces, and improved alignment and attachment of components, contributing to the overall performance and efficiency of the brake system.

According to a further embodiment, the half caliper bodies 2, 3 are configured as two separate pieces. This allows for easier manufacturing and assembly, as well as potential weight reduction and improved modularity.

According to a further embodiment, the at least one end bridge comprises two end bridges 23, 24. This configuration provides additional structural support and stability, enhancing the caliper's ability to withstand braking forces.

According to a further embodiment, the two end bridges 23, 24 are connected to each other with a circumferential rod 29. This connection helps maintain alignment and structural integrity, especially under high forces during braking operations.

According to a further embodiment, the two end bridges 23, 24 are formed as a single piece. This design simplifies manufacturing and assembly, potentially reducing production costs and improving structural rigidity.

According to a further embodiment, the two end bridges 23, 24 are separate pieces. This allows for flexibility in design and material selection, potentially optimizing weight and performance characteristics.

According to a further embodiment, each half caliper body 2, 3 is connected to the at least one end bridge 23, 24 via at least one captive screw 30. This ensures secure attachment and alignment, preventing loss of screws during maintenance or assembly.

According to a further embodiment, the at least one central bridge portion 19, 20 comprises two parallel central bridge portions 19, 20 protruding in a cantilevered manner from each half caliper body 2, 3. This configuration enhances structural integrity and load distribution, reducing deformation and improving performance.

According to a further embodiment, the fixed caliper body 1 comprises at least three components connected at three separate union planes: a first plane P2 defined by faced bridge free end surfaces 21, 22 of the opposite central bridge portions 19, 20; a second plane P3 defined by the half caliper coupling surface 27 of the first half caliper body or external body 2 and the first end bridge coupling surface 25 of the at least one end bridge 23; a third plane P1 defined by the half caliper coupling surface 28 of the second half caliper body or internal body 3 and the second end bridge coupling surface 26 of the at least one end bridge 24. This multi-plane connection ensures precise alignment and reduces stress, enhancing structural integrity and performance.

According to a further embodiment, the first plane defined by the faced free end surfaces 21, 22 of the opposite central bridge portions 19, 20 is positioned closer to the internal or second half caliper body 3 in respect of the median plane of the caliper body 1 or the median plane of the disc brake 14. This positioning optimizes load distribution and structural support, reducing deformation and improving performance.

According to a further embodiment, the central bridge portion 20 of the second half caliper body 3, or internal half caliper body 3, comprises a central bridge through seat 31 for a captive screw 30, and the central bridge portion 19 of the first half caliper body 2, or external half caliper body 2, comprises a central bridge threaded blind hole 32 for said captive screw 30 in order to connect the two half caliper bodies 2, 3. This connection ensures secure attachment and alignment, enhancing structural integrity and performance.

According to a further embodiment, the half caliper end portion 17, 18 of the half caliper body 2, 3 comprises at least one half caliper end portion thorough hole 33 for receiving a captive screw 30, and the end bridge 23, 24 comprises an end bridge thread blind hole 34 for connecting said captive screw 30 and connecting the half caliper body 2, 3 to the end bridge 23, 24. This configuration ensures secure attachment and alignment, enhancing structural integrity and performance.

According to a further embodiment, the first and second half caliper bodies 2, 3 are made of a first material, and the at least one end bridge 23, 24 is made of a second material, different from said first material. This material selection optimizes weight and performance characteristics, enhancing structural integrity and efficiency.

According to a further embodiment, the half caliper bodies 2, 3 are made of aluminum. This material choice reduces weight while maintaining structural integrity, enhancing performance and efficiency.

According to a further embodiment, each end bridge 23, 24 is made of cast iron. This material choice provides high strength and durability, enhancing structural integrity and performance.

According to a further embodiment, all the half caliper coupling surfaces 27, 28 of the same half caliper body 2 or 3 are machined in a single working step and at the same time to reduce the geometrical coupling tolerances between them, creating a single coupling plane to couple said half caliper body 2 or 3 with the at least one end bridge 23, 24. This machining process ensures precise alignment and reduces stress, enhancing structural integrity and performance.

According to a further embodiment, all the end bridge coupling surfaces 25 or 26 facing the same side are machined in a single working step and at the same time to reduce the geometrical coupling tolerances between them, creating a single coupling plane to couple the at least one end bridge 23, 24 with the same of said half caliper body 2 or 3. This machining process ensures precise alignment and reduces stress, enhancing structural integrity and performance.

According to a further embodiment, each end bridge 23, 24 comprises at least one abutment surface 45 to abut one of said pads 12, 13 in circumferential direction during the braking action. This feature ensures secure attachment and alignment, enhancing structural integrity and performance.

Those skilled in the art may make many changes and adaptations to the embodiments described above or may replace elements with others which are functionally equivalent in order to meet contingent needs without however departing from the scope of protection as described and claimed herein.

### LIST OF REFERENCES

1 fixed caliper body
2 half caliper body -first body - external body
3 half caliper body - second body - internal body
4 thrust seat - external thrust seat
5 thrust seat - external thrust seat
6 thrust seat - internal thrust seat
7 thrust seat - internal thrust seat
8 thrust device - external thrust device
9 thrust device - external thrust device
10 thrust device - internal thrust device
11 thrust device - internal thrust device
12 pad - external pad
13 pad - internal pad
14 disc brake disc
15 central portion - external central portion of the external half caliper body
16 central portion - internal central portion of the external half caliper body
17 half caliper end portion - first half caliper end portion - disc inlet side
18 half caliper end portion - second half caliper end portion - disc outlet side
19 central bridge portion - external central bridge portion
20 central bridge portion - internal central bridge portion
21 bridge free end surface - external bridge free end surface
22 bridge free end surface - internal bridge free end surface
23 end bridge - first end bridge - disc inlet side end bridge
24 end bridge - second end bridge - disc outlet side end bridge
25 end bridge coupling surface - externally faced end bridge coupling surface
26 end bridge coupling surface - internally faced end bridge coupling surface
27 half caliper coupling surface disc inlet side
28 half caliper coupling surface disc outlet side
29 circumferential rod
30 captive screw
31 central bridge through hole
32 central bridge threaded blind hole
33 half caliper end portion through hole
34 end bridge threaded blind hole
37 disc braking surface
38 disc braking surface
39 axial-symmetric disc body
40 spring for pads suitable at least to constantly influence the pad away from the disc in order to avoid residual braking torque
41 pad guiding pin
42 braking fluid duct suitable to connect external body with internal body
43 bleeding device
44 eventual gap between the faced bridge free end surfaces of the opposite central bridge portions
45 pad abutment surface
A-A axial direction
X-X disc brake rotation axis
R-R radial direction
C-C circumferential direction
P1 third plane defined by the half caliper coupling surface of the second half caliper body or internal body and the second end bridge coupling surface of the at least one end bridge
P2 first plane defined by faced bridge free end surfaces of the opposite central bridge portions
P3 second plane defined by the half caliper coupling surface of the first half caliper body or external body and the first end bridge coupling surface of the at least one end bridge.

1. A fixed caliper body for a disc brake disc wherein
said disc comprising opposite braking surfaces and an axial-symmetric disc body adapted to rotate about a rotation axis (X-X) defining an axial direction (A-A), said disc body (39) developing radially along a radial direction (R-R) orthogonal to said axial direction (X-X), as well as along a circumferential direction orthogonal both to said axial direction (X-X) and to said radial direction (R-R);
said fixed caliper body comprising:
two half caliper bodies;
each half caliper body comprising at least one thrust seat for at least one thrust device able to push at least one pad against a disc brake;
each half caliper body comprising a central portion above the at least one seat for at least one thrust device;
each half caliper body comprises at least one half caliper end portion disposed circumferentially outside the at least one thrust seat for at least one thrust device;
each half caliper body comprises at least one central bridge portion which protrudes in a cantilevered manner in axial direction (X-X) and is connected in one piece to said central portion;
said at least one central bridge portion comprising a bridge free end surface facing the opposite bridge free end surface of the faced half caliper body to create a bridge able to straddle the disc brake and create a tierod suitable to be above the pads;
the caliper body further comprising at least one end bridge made as a separate piece in respect of said half caliper bodies and suitable to straddle said disc; said at least one end bridge having faced away end bridge coupling surfaces;
each at least one half caliper end portion comprising a half caliper coupling surface facing said end bridge coupling surface to firmly connect in a removable manner said half caliper bodies with said at least one end bridge;
wherein said two half caliper bodies are configured such that they directly face each other when not on the disc brake and the pad is removed, and such that the disc brake and pad are interposed between the two half caliper bodies when the two half caliper bodies are on the disc brake and the pad is present.

2. The fixed caliper body of claim 1, wherein the half caliper bodies are configured as two separate pieces.

3. The fixed caliper body of claim 1, wherein the at least one end bridge comprises two end bridges.

4. The fixed caliper body of claim 1, wherein the two end bridges are connected to each other with a circumferential rod.

5. The fixed caliper body of claim 3, wherein the two end bridges are formed as a single piece.

6. The fixed caliper body of claim 3, wherein the two end bridges are separate pieces.

7. The fixed caliper body of claim 1, wherein each half caliper body is connected to the at least one end bridge via at least one captive screw.

8. The fixed caliper body of claim 1, wherein the at least one central bridge portion comprises two parallel central bridge portions protruding in a cantilevered manner from each half caliper body.

9. The fixed caliper body of claim 1, comprising at least three components connected at three separate union planes:
a first plane (P2) defined by faced bridge free end surfaces of the opposite central bridge portions;
a second plane (P3) defined by the half caliper coupling surface of the first half caliper body or external body and the first end bridge coupling surface of the at least one end bridge;
a third plane (P1) defined by the half caliper coupling surface of the second half caliper body or internal body and the second end bridge coupling surface of the at least one end bridge.

10. The fixed caliper body of claim 9, wherein the first plane defined by the faced bridge free end surfaces of the opposite central bridge portions is positioned closer to the internal or second half caliper body in respect of the median plane of the caliper body or the median plane of the disc brake.

11. The fixed caliper body of claim 1, wherein the central bridge portion of the second half caliper body, or internal half caliper body, comprises a central bridge through hole for a captive screw and the central bridge portion of the first half caliper body, or external half caliper body, comprises a central bridge threaded blind hole for said captive screw in order to connect the two half caliper bodies.

12. The fixed caliper body of claim 1, wherein the half caliper end portion of the half caliper body comprises at least one half caliper end portion through hole for receiving a captive screw and the end bridge comprises an end bridge thread blind hole for connecting said captive screw and connecting the half caliper body to the end bridge.

13. The fixed caliper body of claim 1, wherein the first and second half caliper bodies are made of a first material and the at least one end bridge is made of a second material, different from said first material.

14. The fixed caliper body of claim 1, wherein the half caliper bodies are made of aluminum.

15. The fixed caliper body of claim 1, wherein each end bridge is made of cast iron.

16. The fixed caliper body of claim 1, wherein all the half caliper coupling surfaces of the same half caliper body are machined in a single working step and at the same time in order to reduce the geometrical coupling tolerances between them, creating a single coupling plane to couple said half caliper body with the at least one end bridge.

17. The fixed caliper body of claim 1, wherein all the end bridge coupling surfaces facing the same side are machined in a single working step and at the same time in order to reduce the geometrical coupling tolerances between them, creating a single coupling plane to couple the at least one end bridge with the same of said half caliper body.

18. The fixed caliper body of claim 1, wherein each end bridge comprises at least one abutment surface to abut one of said pads in circumferential direction during the braking action.

19. A brake disc assembly comprising:
the fixed caliper body of claim 1, wherein the caliper body is disposed straddling the disc brake;
said disc brake comprising opposite braking surfaces and an axial-symmetric disc body adapted to rotate about a rotation axis (X-X) defining an axial direction (A-A), said disc body developing radially along a radial direction (R-R) orthogonal to said axial direction (A-A), as well as along a circumferential direction (C-C) orthogonal both to said axial direction (A-A) and to said radial direction (R-R);
wherein the caliper body is configured to receive brake pads facing the opposite braking surfaces of the disc brake, enabling the application of a braking action on the disc brake.

20. A manufacturing process for producing the fixed caliper body of claim 1, comprising:
forming two half caliper bodies from a first material, such as aluminum, each comprising at least one thrust seat for accommodating thrust devices and a central portion above the thrust seat;
machining all half caliper coupling surfaces of each half caliper body in a single working step to create a single coupling plane, thereby reducing geometrical coupling tolerances and ensuring precise alignment with at least one end bridge;
forming at least one end bridge from a second material, such as cast iron, and machining all end bridge coupling surfaces facing the same side in a single working step to create a single coupling plane for precise alignment with the half caliper bodies;
assembling the caliper body by connecting the machined half caliper bodies to the machined end bridge using captive screws to ensure accurate alignment and secure attachment.

21. The manufacturing process of claim 20, further comprising the step of machining the central bridge portions of each half caliper body to ensure that the bridge free end surfaces are precisely aligned and face each other, forming a bridge that straddles the disc brake and provides structural support for the caliper body.
